(19) United States
(12) Patent Application Publication
(10) Pub. No.: US 2018/0301710 A1
(43) Pub. Date: Oct. 18, 2018

(54) Electrode and Galvanic Cell Comprising a Shaped Body Which Is Composed of Carbon Foam, and Method for Production Thereof

(71) Applicant: Bayerische Motoren Werke Aktiengesellschaft, Muenchen (DE)

(72) Inventors: Holger HAIN, Ismaning (DE); Barbara STIASZNY, Eurasburg (DE)

(21) Appl. No.: 16/013,016

(22) Filed: Jun. 20, 2018

Related U.S. Application Data
(63) Continuation of application No. PCT/EP2016/081491, filed on Dec. 16, 2016.

(30) Foreign Application Priority Data
Dec. 21, 2015 (DE) 10 2015 226 271.5

(51) Int. Cl. H01M 4/80; H01M 10/0525; H01M 10/058; H01M 4/13; H01M 4/139; H01M 4/04; H01M 4/66

(52) U.S. Cl. CPC H01M 4/808; H01M 10/0525; H01M 10/058; H01M 4/663; H01M 4/139; H01M 4/0416; H01M 4/13

(57) ABSTRACT

An electrode and a galvanic cell are provided, each having a shaped body which is composed of porous carbon foam and in the pores of which layers of active material and electrolyte, in particular solid-state electrolytes, are formed. The layer including electrochemical active material is in this case in electrically conductive contact with the shaped body, and the layer including solid-state electrolyte material is in contact with the active material. The electrodes or galvanic cells are particularly suitable for use in electrical energy stores for vehicles, such as in batteries for example, for delivering electrical energy to traction motors of motor vehicles with an electric or hybrid drive and are distinguished in that particularly high energy and power densities of corresponding galvanic cells and batteries manufactured therefrom are possible with them.

### CROSS REFERENCE TO RELATED APPLICATIONS

This application is a continuation of PCT International Application No. PCT/EP2016/081491, filed Dec. 16, 2016, which claims priority under 35 U.S.C. § 119 from German Patent Application No. 10 2015 226 271.5, filed Dec. 21, 2015, the entire disclosures of which are herein expressly incorporated by reference.

### BACKGROUND AND SUMMARY OF THE INVENTION

The present invention relates to electrodes and galvanic cells, each of which includes a shaped body composed of porous carbon foam, and to processes for production thereof. The electrodes or galvanic cells are especially suitable for use in electrical energy storage means for motor vehicles, for instance in batteries for supplying electrical energy to traction motors of motor vehicles with electrical or hybrid drive.

In current electrically operable motor vehicles, what are called lithium ion accumulators in particular are used as electrical energy storage means. In addition, fuel cells and conventional car batteries are also among the known energy suppliers. A common factor for all these energy storage means or suppliers is that the energy densities or power densities achievable therewith are usually lower than in the case of conventional fossil fuels. It is thus fundamentally desirable to further improve the energy or power densities of electrical energy storage means, especially for motor vehicles. This can be achieved firstly by increasing the electrical storage performance capacity of such energy storage means, but secondly also by reducing the mass of such energy storage means which likewise affects the energy or power density. For this purpose, a known method is to use porous foam material for the construction of energy storage means in order to reduce the mass for the same volume.

For instance, U.S. patent application by I. Oladeji, published as US 2013/0108920 A1, describes electrodes for lithium ion batteries and batteries of this kind which contain a structure made of metal foam into which further components have been embedded as a battery component.

U.S. patent application by A. Newman et al., published as US 2009/0291368 A1, describes not only a corresponding production process but also a battery which includes a three-dimensional, porous carbon foam base, wherein the carbon foam base serves as anode and includes a cathode layer, and also a separator layer between the anode and cathode layer. The anode and the cathode layer are each contact-connected via corresponding output conductors.

It is an object of the present invention to further improve electrodes and galvanic cells each including a shaped body composed of porous foam material, and processes for production thereof.

First of all, various electrodes of the invention are described hereinafter.

A first aspect of the invention relates to an electrode for use in a galvanic cell, especially a lithium ion cell. The electrode has a shaped body composed of porous carbon foam and a first layer within the pores of the shaped body having electrochemically active material in electrically conductive contact with the shaped body. In addition, the cell has a second layer within the pores of the shaped body having a solid-state electrolyte material in contact with the active material of the first layer.

As used herein, “shaped body” is understood to mean a three-dimensional solid body with fixed dimensions, made of material which assumes a particular shape in space. More particularly, foam bodies in the form of solid bodies are “shaped bodies” in the context of the invention. This shaped body is preferably deformable in a non-destructive manner, more preferably elastically—with or without elastic hysteresis.

As used herein, “porous carbon foam” is understood to mean an electrically conductive foam structure having a plurality, generally a multitude, of cavities (pores, especially pores having a diameter in the micrometer range), formed from carbon as one constituent, usually a single or at least dominant constituent. Additions other than carbon are thus possible. The foam structure may especially contain substructures consisting of carbon, for instance carbon nanotubes or fullerenes. The aforementioned US 2009/0291368 A1 describes examples of porous carbon foam. In addition, especially the CFOAM® or CSTONE™ products sold under the names by Touchstone Research Laboratory, Ltd. (www.cfoam.com) are further examples of porous carbon foams in the context of the invention.

As used herein, an “electrochemical active material” or “active material” is understood to mean a material that determines the electrochemical properties of an electrode of a galvanic element. Especially for lithium ion cells, electrochemical active materials in the context of the invention (i) for the negative electrode are especially graphite and related carbons in which integration of lithium can take place, silicon, metallic lithium, Li₄Ti₅O₁₂ and SnO₂, and (ii) for the positive electrode are especially FeF₃ and lithium-metal compounds such as LiCoO₂, LiNiO₂, LiNi₁₋ₓCoₓO₂, LiNi_{0.85}Co_{0.01}Al_{0.05}O₂, LiNi_{0.33}Co_{0.33}Mn_{0.33}O₂, LiMn₂O₄ and LiFePO₄.

As used herein, a “solid-state electrolyte material” is understood to mean an electrically conductive solid in which the conductivity is caused predominantly by ion flux, while only distinctly lower electronic conductivity is present. More particularly, ceramic- or polymer-based electrolyte materials are solid-state electrolyte materials in the context of the invention, for instance polyethylene oxide (PEO), polyvinylidene fluoride-hexafluoropropylene (PVDF-HFP) or garnet (Li₇La₃Zr₂O₁₂).

One feature of the electrode of the present invention is that it has been formed by means of a shaped body composed of carbon foam. This material can be produced with a very low bulk density which is especially below 1 g/cm³ or even below 0.1 g/cm³. It is possible here to create a porosity exceeding 80% or even higher, such that an extremely high inner surface area formed by the surface area of the pores in the shaped body relative to the volume of the shaped body is available for the arrangement of active material and a solid-state electrolyte material assigned to the respective electrode. In this way, when electrodes of this kind are used in galvanic cells, much higher volumetric and/or gravimetric energy and power densities are achievable than in the case of conventional cell and battery designs, especially of lithium ion batteries. The porous carbon structure of the carbon foam additionally enables particularly good current collection because of its high surface area and the contact to the active material mediated thereby, such that, when electrodes of this kind are used in a galvanic cell, compared to the use of conventional electrodes, it is possible to achieve a lower internal resistance and, as a result, also lower heating. This in turn requires lower power loss and higher performance of the cell.

In addition, the shaped body, owing to its electrical conductivity resulting from the carbon foam material, can also be used directly as output conductor, such that there is no need for an additional output conductor. This additionally enables a further increase in the energy or power density of galvanic cells and batteries having one or more electrodes of this kind. In addition, such electrodes of the invention are suitable, especially when the shaped bodies thereof are in elastic form, also to use active materials having a significant increase or decrease in volume on lithiation/delithiation that proceeds in the operation of the electrode in a lithium ion cell. Materials of this kind may especially be Si, Fe₂O₃, FeF₃, Sn, Zn or Al.

The electrode of the present invention additionally enables flexible cell design, since the shape of the shaped body may be configured very differently. More particularly, the electrode is also usable in cell stacks.

There follows a description of preferred embodiments of the electrode:

In one preferred embodiment, the first layer is formed on pore surfaces of the shaped body, and it is in electrically conductive contact with the shaped body. The second layer is arranged at least partly atop the first layer, such that the following layer sequence is present at that point in the shaped body: carbon foam—active material—solid-state electrolyte.

As used herein, a “layer sequence” is understood to mean that the layers mentioned follow one another in the sequence mentioned in each case in a direction of consideration running from the first layer mentioned to the last layer mentioned in each case. However, it is additionally also possible for one or more further layers to be integrated into the layer sequence, or for individual layers among those mentioned to consist of multiple superposed sublayers. It is also possible for each of the layers to have one or more cutouts or to consist of a multitude of unconnected sub-regions.

The electrode of the present invention, in addition to the advantages already mentioned, may additionally, owing to the layer sequence, afford the advantage of particularly good binding of the active material, both firstly to the carbon foam and secondly to the solid-state electrolyte.

In another embodiment, the second layer has been formed on pore surfaces of the shaped body and is in contact with the shaped body. The first layer is arranged at least partly atop the second layer, such that the layer sequence of carbon foam—solid-state electrolyte—active material is present at that point in the shaped body, and the first layer is in electronically conductive contact with the shaped body at at least one point. In this electrode, it is advantageously possible for the thickness of the layer of solid-state electrolyte to be made very thin by virtue of a corresponding process regime, such that a large amount of active material can be introduced in a particularly simple manner in the cavities remaining above it in the pores of the carbon foam by “filling them up”, in order to achieve a maximum performance of the electrode.

In a further preferred embodiment, the shaped body and the first layer have been bonded by means of a binder, especially an electrically conductive binder. In this way, the strength of an adhesion of the first layer on the carbon foam of the shaped body can be increased even further.

In a further preferred embodiment, the electrode additionally has a layer which takes the form of a separator layer and has been arranged on at least one side of the outer surface of the shaped body and includes a solid-state electrolyte material. This separator layer acts as a separator in the electrochemical sense, meaning that it takes the form firstly of an insulation layer for electrical insulation of the electrode (with respect to its counter-electrode in a galvanic cell). On the other hand, however, it is permeable at least to particular ions, in order that the electrochemical reactions can proceed in a galvanic cell with such an electrode. In the case of an electrode for a lithium ion cell, the separator layer is thus permeable to lithium ions in particular. The “outer surface area” of the shaped body made from porous carbon foam is understood here—as opposed to its “inner surface area” defined by the surface area of the pores in its interior—its outwardly visible or accessible macroscopic surface area. In the case of an illustrative shaped body in cuboid form, this would thus be the surface which is formed from the six sides of the cuboid.

In this way, the electrode can already take the form of a component for such a cell having the separator function of a galvanic cell, such that the later production of a cell with use of such an electrode can be correspondingly simplified, since there is no need to incorporate a separate separator. Moreover, it is thus possible to achieve improved mechanical and electrolytic coupling of the separator layer to the shaped body of the electrode compared to the case of a separate separator. For this purpose, the separator layer may especially have been deposited atop the shaped body.

There now follows a description of variants of galvanic cells of the invention, in which, in turn, at least one electrode has been formed within the shaped body composed of carbon foam, in which both active material and electrolyte have in turn been deposited in the shaped body—as already in the case of the above-described electrodes of the invention.

A second aspect of the invention relates to a galvanic cell, especially a lithium ion cell, containing a first electrode according to the first aspect of the invention. The electrode has a layer in the form of a separator layer arranged on at least one side of the outer surface of the shaped body and has a solid-state electrolyte material (comparing with the above-described embodiment of an electrode with a layer in the form of a separator layer). In addition, the cell has a second electrode, the active material of which has been chosen such that it acts as a counter-electrode to the first electrode. The second electrode may preferably likewise take the same form as the electrode according to the first aspect of the invention. The two electrodes are arranged relative to one another such that the separator layer of the first electrode is arranged between the shaped body and the second electrode in order to separate them.

In this galvanic cell, it is possible to utilize the possible advantages already described above in connection with the electrodes. In addition, it is possible to select the electrodes of the cell as identical electrodes, or else as different electrodes, and optionally to replace them individually. Thus, while the first electrode takes the form of an inventive electrode having a shaped body made of carbon foam, the second electrode may either likewise take the form of an inventive electrode, or else take the form of another electrode, especially of a conventional electrode (for example of a metal foil made from a corresponding electrode material).

A third aspect of the invention relates to an alternative design of a galvanic cell, especially a lithium ion cell. This galvanic cell has a shaped body composed of porous carbon foam and a first layer of active material for the first electrode arranged atop the shaped body in the pores thereof. In this case, the active material for the first electrode and the material of the layer composed of carbon foam have a different chemical composition. In addition, the cell has a second layer which is arranged atop the first layer and takes the form of a separator layer and includes a solid-state electrolyte material, and also a third layer of active material for a second electrode which is arranged atop the second layer and has been chosen such that the second electrode acts as a counter-electrode to the first electrode. In addition, the cell optionally has an output conductor layer for the second electrode arranged atop the first layer, so as to give the following layer sequence: carbon foam—active material of the first electrode—separator layer—active material of the second electrode—optionally output conductor of the second electrode. The output conductor layer for the second electrode may especially include or preferably be manufactured at least essentially from aluminum in the case of a positive electrode, and copper in the case of a negative electrode. If the third layer of active material for the second electrode is suitable for simultaneously functioning as output conductor layer, the additional of the conductor layer for the second electrode, by contrast, may be dispensed with. This is possible especially when the third layer includes metallic lithium as active material. In addition, the use of electrically conductive carbon as material is possible for both types of electrode. This cell thus constitutes a further development of the electrode according to the first embodiment of the electrode and according to the first aspect of the invention, in which the first electrode corresponds to an above-described electrode and, in addition, by means of the further layers, the construction has been supplemented to form a complete galvanic cell.

In this galvanic cell, by contrast with the cell according to the second aspect of the invention, both electrodes of the cell have been formed in the same shaped body composed of porous carbon foam. The entire electrochemical layer stack, as constituted in the layer sequence mentioned, is thus formed within the shaped body. Thus, the size of the cell is at least substantially already fixed by the size of the shaped body, and it is possible to achieve particularly high energy and power densities of the cell. Preferably, the first electrode, i.e., the carbon foam with the different active material of the first electrode, serves as the negative electrode of the cell, and the second electrode, i.e., the active material of the second electrode with the second output conductor, then correspondingly forms the positive electrode.

Since the active material of the first electrode differs from the material of the shaped body, it can be chosen independently therefrom. This allows corresponding flexibility in the material selection, which can be utilized for adjustment, especially optimization, of the cell properties in the same shaped body. More particularly, the material selection for the active material of the first electrode can thus be made independently of the electronic conductivity thereof, since this is of course already provided via the shaped body for the first electrode. In addition, the diffusion pathways for ion conduction are particularly short, which in turn enables acceleration of the discharging or charging of the cell and hence an increase in the power density or a shortening of the charging time. The same also applies to the other cells of the invention that are described herein.

A fourth aspect of the invention relates to a further alternative design of a galvanic cell, especially a lithium ion cell. This cell has a first electrode including a shaped body composed of porous carbon foam and an electrochemical active material which has been introduced into the shaped body and therein forms a first layer on pore surfaces of the shaped body which is in electrically conductive contact with the shaped body. In addition, the cell has a second electrode, the active material of which has been chosen such that it acts as a counter-electrode to the second electrode, and a separator layer arranged between the first electrode and the second electrode. The cell additionally has a liquid electrolyte which is present in the spatial region between the two electrodes and is in contact with the separator layer, such that the two electrodes are connected in an ion-conductive manner via the electrolyte and the separator layer.

This cell type is thus a variant of a galvanic cell which is of similar construction to the cell according to the second aspect of the invention, but in which, rather than a solid-state electrolyte, a liquid electrolyte is used. Useful electrolyte materials include, in particular, the liquid electrolyte types known for lithium ion cells, for instance those based on lithium salts such as LiPF₆, LiBF₄, LiBoB or LiTFSI. The separators used here may likewise be known separators, especially composed of those materials as known for conventional lithium ion accumulators, for instance polyolefin-based separators (e.g., PP, PE) or cellulose-based or glass fiber-based separators.

A fifth aspect of the invention that builds on this cell type relates to an electrical energy storage means including a housing and at least one galvanic cell according to the fourth aspect disposed in an accommodation space of the housing. In this case, at least one shaped body of the cell is in elastic form and has been introduced into the accommodation space in a compressed state. In a preferred embodiment, this housing has been designed such that the dimensions and/or the volume of its accommodation space intended for accommodating galvanic cells can be variably adjusted at least once. In this way, it is possible to variably fix a pressure to which the shaped body of the at least one cell is subject in the accommodation space. Thus, the porosity of the shaped body resulting from the pressure can be controlled before the liquid electrolyte is introduced into the cell and it also penetrates into the remaining cavities in the pores. The porosity in turn affects the behavior of the resulting cell, since it affects the mass ratio or volume ratio for the active material deposited in the pores. Given the same cell construction and hence the same production, the cell can thus be optimized in a controlled manner for a desired end use. More particularly, by means of an appropriate adjustment, the performance of the cell can be emphasized (referred to as “power cell”), in that the porosity is preserved or only slightly reduced by means of a low pressurization and hence a large amount of liquid electrolyte is available, which forms a high common cross-sectional area with the electrode and hence enables rapid ion transport. Alternatively, however, the energy density of the cell can also be emphasized (referred to as “energy cell”), in that the porosity is reduced by means of high pressurization and hence optimal filling of the volume with active material is provided. Thus, the amount of the active material deposited in the pores and hence the chosen energy density of the cell can be set higher without losing the minimum amount of cavity space in the pores required for the electrolyte.

There now follows a description of various processes for producing the electrodes of the invention:

A sixth aspect of the invention relates to a process for producing an electrode according to the first aspect of the invention, especially the above-described first embodiment thereof. The process has the following steps: providing a shaped body composed of porous carbon foam, a carbon foam precursor or a combination of the two as a first component; providing an active material for the electrode, a corresponding active material precursor or a combination of the two as a second component; mechanically mixing the first component and the second component; if the first component includes a carbon foam precursor or the second component includes an active material precursor, converting this/these precursor(s) in order to obtain a shaped body composed of porous carbon foam with active material for the electrode deposited in the pores thereof; infiltrating the shaped body obtained with a third component including a solid-state electrolyte material, a corresponding solid-state electrolyte material precursor or a combination of the two; and if the third component includes a solid-state electrolyte material precursor, converting this precursor in order to produce a layer including solid-state electrolyte material arranged atop the active material for the electrode in the shaped body.

In this way, it is first possible to form a composite structure composed of a shaped body composed of porous carbon foam and an active material for the electrode, which is then provided with a solid-state electrolyte material. This brings the advantage of a particularly simple process regime, since the cavities or pores remaining at first in the composite are completely filled up with solid-state electrolyte in the electrode without any need to accurately set the amount of the solid electrolyte beforehand or to control it during the process regime for the purpose.

“Precursor” in the context of the invention is understood to mean a substance which enters into a reaction as starting material (reactant) in a synthesis pathway, and from which, possibly with involvement of further precursors, another product, especially one which is complex and differentiated, is formed. A selection of preferred precursors for the processes disclosed herein is described further down in the elucidation of selected working examples in connection with the figures.

A seventh aspect of the invention relates to a further process for producing an electrode according to the first aspect of the invention, especially the above-described second embodiment thereof. The process has the following steps: providing a shaped body composed of porous carbon foam, a carbon foam precursor or a combination of the two as a first component; providing a solid-state electrolyte material or a solid-state electrolyte material precursor or a combination of the two as a second component; mechanically mixing the first component and the second component; if the first component includes a carbon foam precursor or the second component includes a solid-state electrolyte material precursor, converting this/these precursor(s) in order to obtain a shaped body composed of porous carbon foam with solid-state electrolyte material deposited in the pores thereof; infiltrating the shaped body obtained with a third component including an active material for the electrode, a corresponding active material precursor or a combination of the two; and if the third component includes an active material precursor, converting the active precursor in order to produce an active material layer arranged atop the solid-state electrolyte in the shaped body.

In this way, it is first possible to form a composite structure composed of a shaped body composed of porous carbon foam and a solid-state electrolyte material, which is then provided with an active material for the electrode. This brings the advantage that, given choice of suitable process parameters, a thin layer of solid electrolyte material can be formed atop the first component, such that the amount of electrochemically inactive solid-state electrolyte material in the electrode is kept small, especially as small as possible, without endangering the functionality of the layer. It is thus possible to maximize the cavity space remaining in the pores for the subsequently introduced active material of electrochemical relevance, which is advantageous especially with regard to a higher performance and energy density of a galvanic cell formed with the electrode.

An eighth aspect of the invention relates to a further process for producing an electrode according to the first aspect of the invention. The process has the following steps: providing a carbon foam precursor as a first component, a solid-state electrolyte material or a solid-state electrolyte material precursor or a combination of the two as a second component, and a third component including an active material for the electrode, a corresponding active material precursor or a combination of the two; mechanically mixing the first, second and third components; converting any precursors present in the first, second and third components in order to obtain a shaped body composed of porous carbon foam, in the pores of which solid-state electrolyte material and active material for the electrode have been deposited, wherein the converting is effected in such a way that the converting of the carbon foam precursor commences prior to the converting of any precursors present for the second and third components; and wherein, in the mixing, the introduction of the second and third component(s) into the mixture begins successively or, when the second and third components contain precursors, the converting of the second and third components begins successively, wherein the sequence of introduction and conversion is chosen depending on the layer sequence of the components which is to be produced in the electrode.

This process can be used especially advantageously in order to alternatively produce electrodes in the first or second embodiment of the first aspect of the invention solely as a function of process parameters, especially the sequence and duration of process steps, or to adjust or to optimize the formation thereof from the three components, especially the thicknesses and homogeneity of the individual layers, in a correspondingly parameter-dependent manner.

In preferred embodiments of the aforementioned processes for producing electrodes, before or in the course of mixing of the components, a binder, especially a conductive binder, is added as a fourth component. In this way, it is possible to further improve the adhesion of the individual layers, especially the first layer on the shaped body.

When, in the aforementioned processes, a precursor is used for the first or second component or both, the reaction product of which acts as a binder, it is advantageously possible in the conversion thereof to achieve better adhesion of the two components to one another than is possible in the case of a purely mechanical mixture of end products i.e. in the case of mixing-in or introducing of the second component into the finished shaped body composed of carbon foam. It is thus often possible, especially when precursors are used, to dispense with the addition of an additional binder, or in any case to reduce the amount thereof in order to achieve the same degree of adhesion.

There now follows a description of processes for producing galvanic cells of the invention.

A ninth aspect of the invention relates to a process for producing a galvanic cell according to the second aspect of the invention. The process has the following steps: coating a first electrode according to the first aspect of the invention with a layer of a material including a solid-state electrolyte to form a separator layer of the cell; and arranging a second electrode, the active material of which has been chosen such that it acts as a counter-electrode to the first electrode, atop the separator layer such that it separates the first and second electrodes.

In this way, it is possible to produce a galvanic cell from the electrodes of the invention, in which the dimensions and materials of the two electrodes can be chosen substantially independently of one another. Further advantages have already been described in connection with the second aspect of the invention.

A tenth aspect of the invention relates to a process for producing a galvanic cell according to the third aspect of the invention. The process has the following steps: providing a shaped body composed of porous carbon foam, a carbon foam precursor or a combination of the two as the first component; introducing an active material for a first electrode, a corresponding active material precursor or a combination of the two as a second component into the first component; if the first component includes a carbon foam precursor or the second component includes an active material precursor, converting this/these precursor(s) in order to obtain a shaped body composed of porous carbon foam with active material for the first electrode deposited in the pores thereof; infiltrating the shaped body obtained with a third component including a solid-state electrolyte material, a corresponding solid-state electrolyte material precursor or a combination of the two; and, if the third component includes a solid-state precursor material, converting this precursor in order to produce a layer including solid-state electrolyte material arranged within the shaped body atop the active material for the first electrode; introducing an active material for a second electrode, a corresponding active material precursor or a combination of the two as a fourth component into the shaped body; if the fourth component includes an active material precursor, converting this precursor in order to produce a layer of active material for a second electrode atop the layer including the solid state electrolyte material; introducing an electrically conductive material for an output conductor of the second electrode, a corresponding conductive material precursor or a combination of the two as a fifth component into the shaped body; and if the fifth component includes a conductive material precursor, converting this precursor in order to produce an electrically conductive output conductor layer for the second electrode on the layer of active material for the second electrode.

In this way, it is possible to produce a galvanic cell which, owing to its high compactness, can have a particularly high power density or energy density. Further advantages have already been described in connection with the third aspect of the invention.

An eleventh aspect of the invention relates to a process for producing a galvanic cell according to the fourth aspect of the invention. The process has the following steps:

arranging a between a first electrode, a second electrode and a separator layer in an accommodation space of a housing, such that the separator layer separates the first and second electrodes from one another, wherein the first electrode comprises a shaped body composed of porous carbon foam and an electrochemical active material which has been introduced into the shaped body and therein forms a first layer on pore surfaces of the shaped body which is in electrically conductive contact with the shaped body, and the active material of the second electrode is chosen such that it acts as a counter-electrode to the first electrode; and filling the accommodation space with a liquid electrolyte, such that the electrolyte penetrates into the first electrode and is in contact with the separator layer and the second electrode, such that the two electrodes are connected in an ion-conductive manner via the electrolyte and the separator layer.

In this way, using at least one electrode having a shaped body composed of carbon foam, it is possible to produce a galvanic cell with a liquid electrolyte. Further advantages have already been described in connection with the fourth aspect of the invention.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a schematic of the construction of an electrode according to a preferred embodiment of the invention.

FIG. 2 shows a schematic of the construction of an electrode according to a further preferred embodiment of the invention.

FIG. 3 shows a schematic of a first process step of a first process according to a preferred embodiment of the invention for production of an electrode according to FIG. 1.

FIG. 4 shows a schematic of a further process step of the first process for producing an electrode according to FIG. 1.

FIG. 5 shows a schematic of a first process step of a second process according to a preferred embodiment of the invention for producing an electrode according to FIG. 2.

FIG. 6 shows a schematic of a further process step of the second process for producing an electrode according to FIG. 2.

FIG. 7 shows a schematic of process steps of a further process in a preferred embodiment of the invention for optional production of an electrode according to FIG. 1 or FIG. 2.

FIG. 8 shows a schematic of a fourth process for producing a galvanic cell with electrodes according to FIG. 1 and/or FIG. 2.

FIG. 9 shows a galvanic cell according to a preferred embodiment of the invention with electrodes according to FIG. 1 and/or FIG. 2.

FIG. 10 shows a galvanic cell with according to a further preferred embodiment of the invention, in which both electrodes of the cell are formed within the same shaped body composed of carbon foam.

FIG. 11 shows a galvanic cell according to a preferred embodiment of the invention with electrodes each formed in a dedicated shaped body composed of carbon foam and a liquid electrolyte.

In the figures which follow, the same reference numerals are used across the board for the same or corresponding elements of the invention.

### DETAILED DESCRIPTION OF THE DRAWINGS

First of all, there is a description of electrodes according to preferred embodiments of the invention and processes for production thereof.

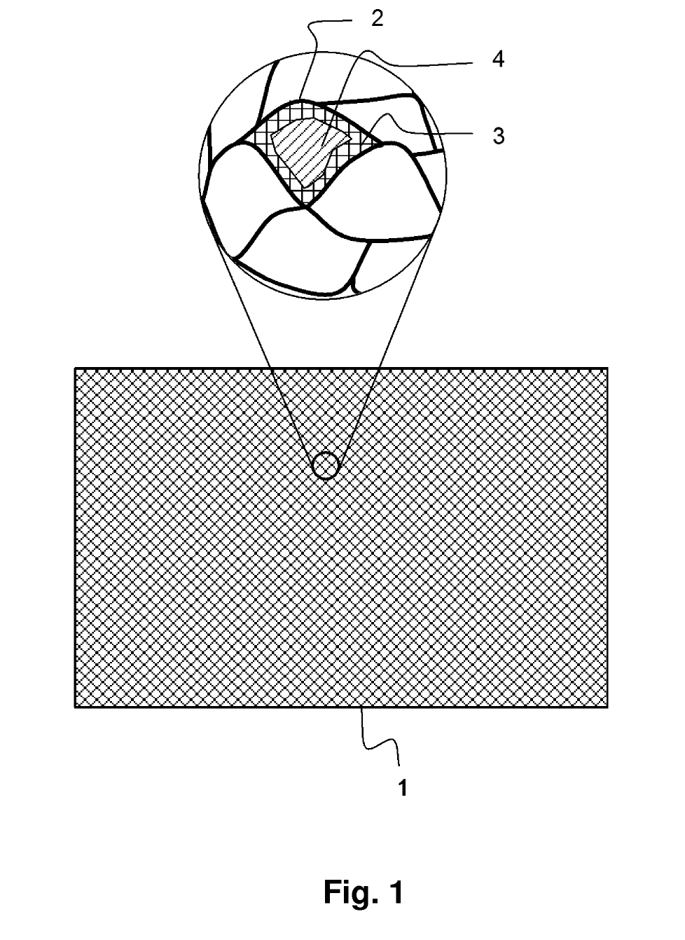

FIG. 1 shows an electrode according to a first preferred embodiment of the invention, formed in a shaped body 1 composed of porous carbon foam 2. The upper portion of the figure shows an enlarged detail from the shaped body 1 in which, in particular, the pores formed by the carbon foam 2 are apparent as cavities in the shaped body 1. By way of illustration, the filling of one of the pores is shown by way of example in the detail. The filling contains a first layer of active material 3 for the electrode, the first layer having been formed on the surface of the pores. In addition, the filling contains a second layer of solid-state electrolyte material 4 lying at least essentially atop the first layer, which, according to the use of the electrode as anode or cathode, acts as anolyte or catholyte. The second layer preferably completely fills the cavity formed by the pores in the carbon foam 2 together with the first layer.

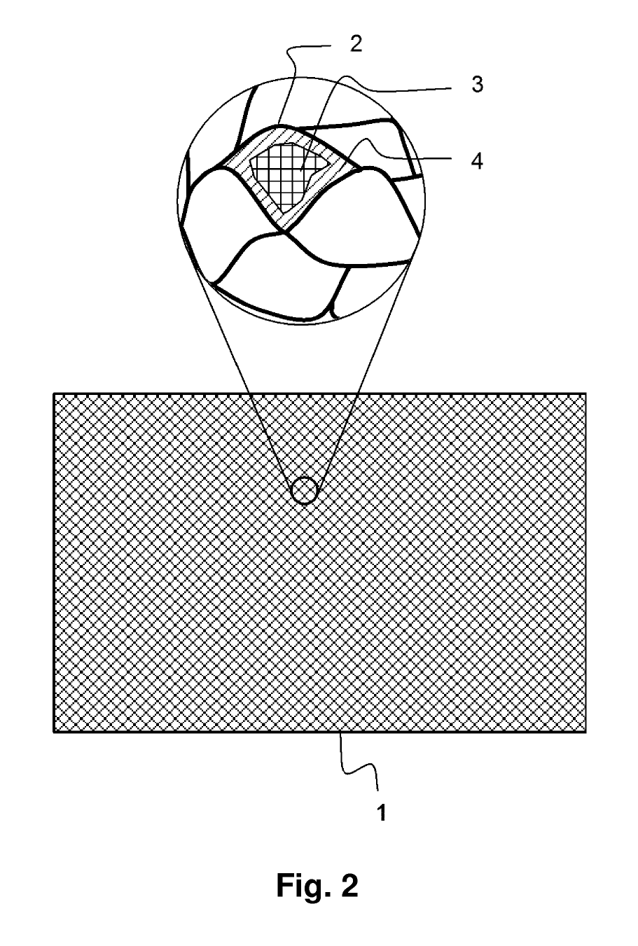

FIG. 2 shows an electrode according to a further preferred embodiment of the invention, again formed in a shaped body 1 composed of porous carbon foam 2. The construction corresponds to that of the electrode from FIG. 1, except that the sequence of the layers of active material 3 and solid-state electrolyte 4 has been switched by comparison. Thus, the carbon foam 2 is directly connected to the layer of solid-state electrolyte 4, on which the layer of active material 3 has been formed in turn.

However, the representation is an idealization to a certain degree. This is because, in the production of a real electrode of this design, it is regularly the case, unless particular measures are taken to avoid it, that not just exact interfacial layers between the individual layers are formed; instead, at least at some points, the layer of active material 4 is in contact not just with the layer of solid-state electrolyte material 3, but also with the carbon foam 2. More particularly, triphasic boundaries are also formed, where the active material is connected both to the electronic conduction pathway of the electrode mediated by the carbon foam and to the ionic conduction pathway of the electrode determined by the solid-state electrolyte. When the layers are correspondingly switched, the same also applies to the electrode according to FIG. 1. However, it is conceivable to define the process regime for production of the electrode by particular measures—for instance use of polymer electrolytes that can be poured in or can be polymerized directly on the carbon of the carbon foam—such that an at least nearly impervious layer of solid-state electrolyte is nevertheless deposited on the carbon foam. In that case, the process should preferably be controlled such that the solid-state electrolyte layer 4 is formed to be so thin that it is still electrically conductive in the direction of the contact with active material 3 (short path) (which will be the case given sufficiently thin layers even if it completely separates and encloses the carbon layer).

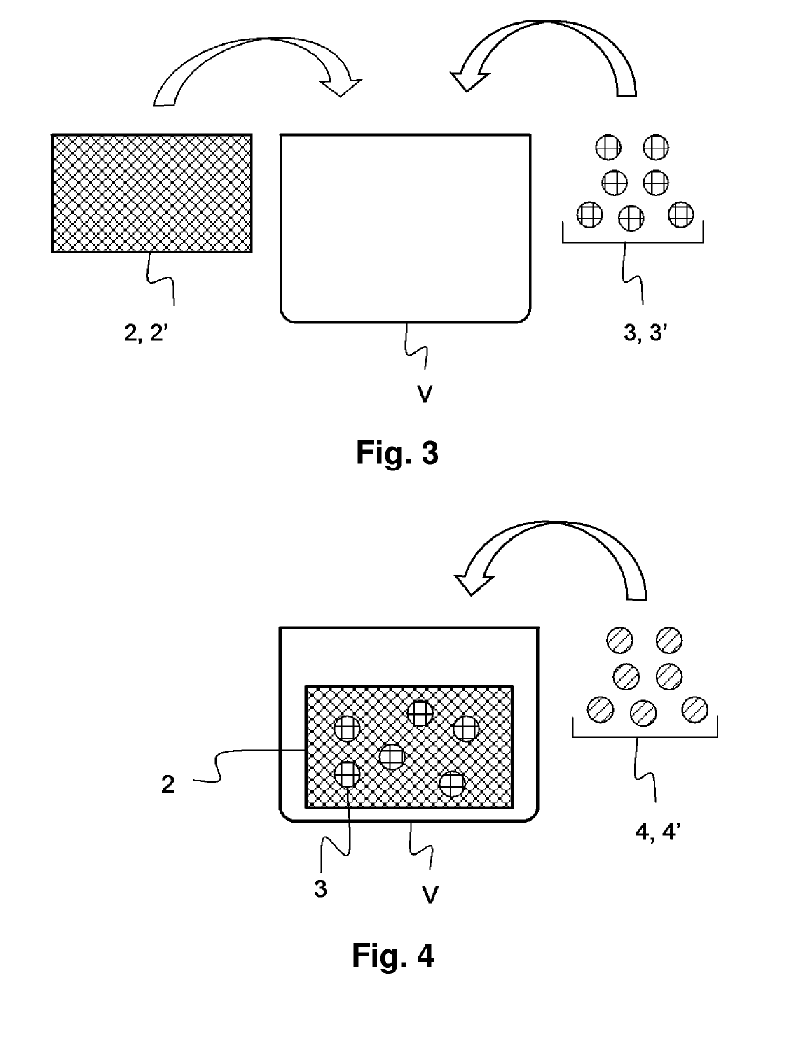

FIGS. 3 and 4 show, in schematic form, process steps of a first process according to a preferred embodiment of the invention for production of an electrode according to FIG. 1. In this case, first of all, according to FIG. 3, a first component including a porous carbon foam 2 or a carbon foam precursor 2′ is introduced into a reaction space V and mixed/admixed with a second component including an active material 3 for the electrode or an active material precursor 3′, such that the second component can penetrate into and be intercalated into the first component. If the first component or second component includes a precursor 2′ or 3′, it is then converted in order to obtain porous carbon foam 2 or active material 3. In the case that an active material precursor 3′ is used, the process, if it still does not have a solid-state foam structure, can be conducted such that, first of all, the conversion of the carbon foam precursor 2′ commences or is even completed before the second component is added and converted, if the latter is an active material precursor 3′. As a result, a shaped body composed of porous carbon foam/active material composite is formed as an intermediate. In a further process step, which is shown in FIG. 4, this shaped body is infiltrated with a third component including a solid-state electrolyte material 4 or a solid-state electrolyte material precursor 4′. The third component is intercalated in the remaining cavities within the pores of the shaped body. If the third component is a solid-state electrolyte material precursor 4′, it is then still converted, such that the result obtained is an electrode in the form of a shaped body 1 according to FIG. 1.

Precursors chosen may, in various preferred embodiments, especially be the following starting materials:

Precursors for carbon foam: polyethylene (PE) foam or polypropylene (PP) foam or mixtures thereof, where the conversion in each case can be effected especially by thermal breakdown at 400-900° C.

Precursors for active material for the electrode(s):
Iron fluoride FeF₃, where the conversion can especially be effected by one of the following routes:
   Fe(NO₃)₃.(H₂O)₉+HF+CTAB, reaction at 80° C., for example in an autoclave, and drying at 180° C.
   FeCl₃+NaOH with HF, reaction at 70° C., drying at 80° C. under reduced pressure.
   Fe₂O₃+F₂ gas, reaction at 500° C.
Si: conversion by depositing silane gas at 400° C.
Fe₂O₃: conversion: Fe acetate, Fe nitrate, Fe acetylacetonate are broken down thermally at 250-500° C. under air.

In the case of common conversion of the precursors of carbon foam and active material: PE foam+Fe₂O₃→heating to 400-900° C.→introducing F₂ gas at 500° C.

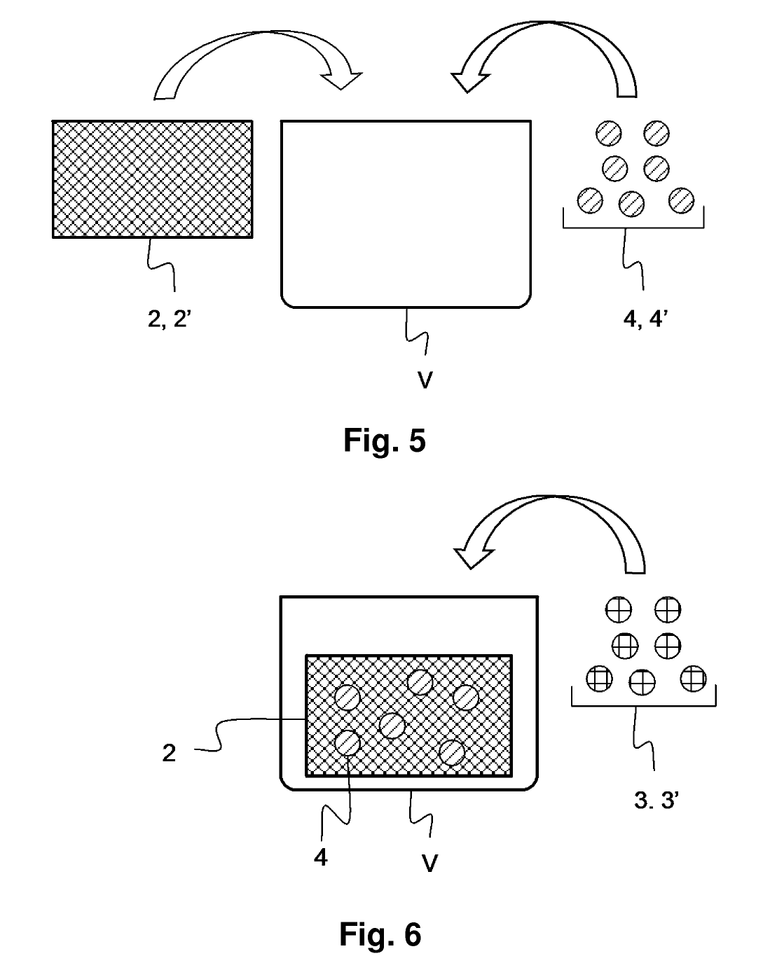

FIGS. 5 and 6 show, in schematic form, process steps of a second process in a preferred embodiment of the invention for producing an electrode according to FIG. 2. The process regime here corresponds to that which has already been elucidated in connection with FIGS. 3 and 4, except that the roles of active material 3 or the precursor 3′ thereof on the one hand and solid-state electrolyte material 4 or the precursor 4′ thereof on the other hand have been switched.

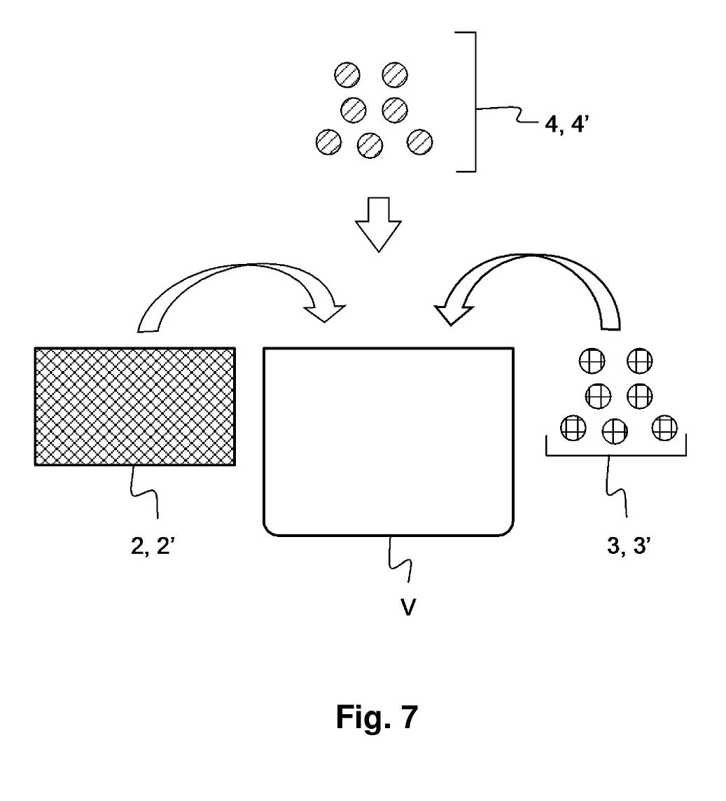

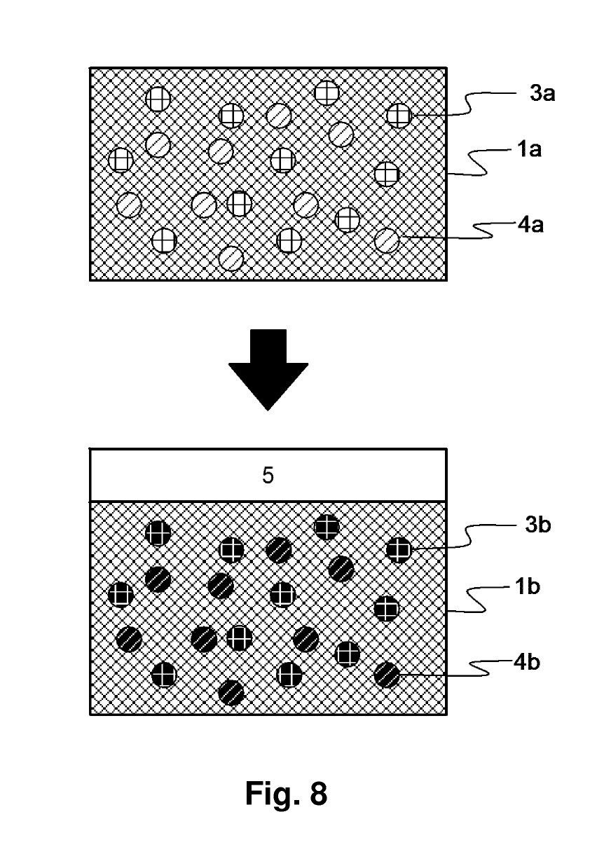

FIG. 7 shows, in schematic form, process steps of a further process in a preferred embodiment of the invention for optional production of an electrode according to FIG. 1 or 2. By contrast with the two above-described processes, the process steps of the commixing of the second and third components and the conversion of the components do not necessarily take place sequentially here. Instead, the first component composed of carbon foam 2 or the precursor 2′ thereof, the second component and the third component, one of which in turn includes an active material 3 or the precursor 3′ thereof and the other includes a solid-state electrolyte material 4 or the precursor 4′ thereof, are already mixed mechanically as individual components before the composite is formed in the reaction space V. In this case, the sequence of commixing of the second or third component can be chosen such that either the second or third component is introduced first into the reaction space V and the component of these two which is introduced first is preferably deposited directly on the pore surfaces of the first component, while the other of these components introduced thereafter essentially fills the remaining cavities. In the case of use of precursors 3′ or 4′, it is possible, moreover, if desired also additionally, to adjust the time sequence of the individual conversion so as to form the desired layer sequence.

There follows a description of galvanic cells according to a preferred embodiment of the invention and processes for production thereof.

FIG. 8 shows, in schematic form, a fourth process for producing a galvanic cell with electrodes according to FIG. 1 and/or FIG. 2. In this case, first of all, an electrode according to FIG. 1 or FIG. 2 which has been formed by means of a shaped body 1b composed of porous carbon foam, which can especially be produced by a process described in connection with FIGS. 3 to 7, is coated with a separator layer 5, preferably composed of solid-state electrolyte material. This layer 5 serves as the separator of the cell. Then this first electrode is joined to a second, second electrode formed by means of a shaped body 1a composed of porous carbon foam which has been designed by appropriate selection of its active material as counter-electrode to the first electrode with the first electrode such that the separator layer 5 is arranged between the two electrodes and an ion conduction pathway is thus formed between the two electrodes. The solid state electrolytes 4a and 4 present in the shaped bodies of the two electrodes chosen may be the same or else—as shown—different, especially in order to achieve optimal adjustment in each case to the respective active material of the corresponding electrode.

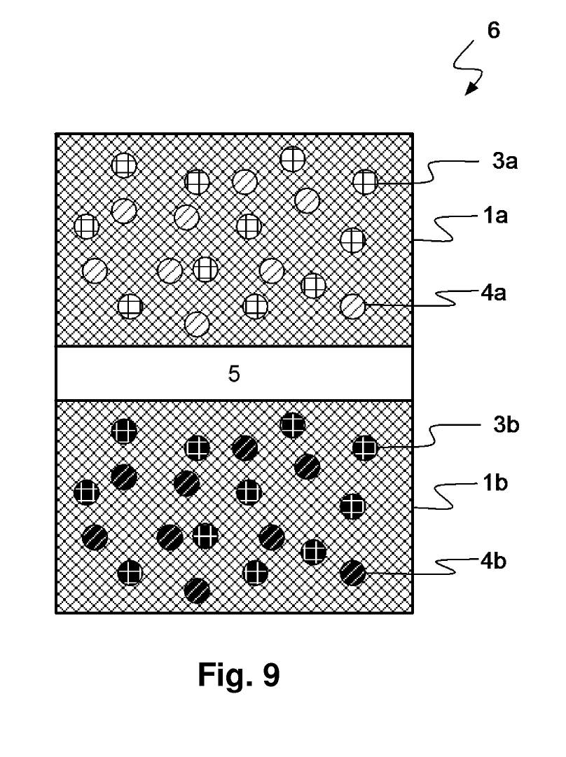

FIG. 9 shows the galvanic cell 6 formed with the aid of the process from FIG. 8, the advantages of which have already been elucidated above.

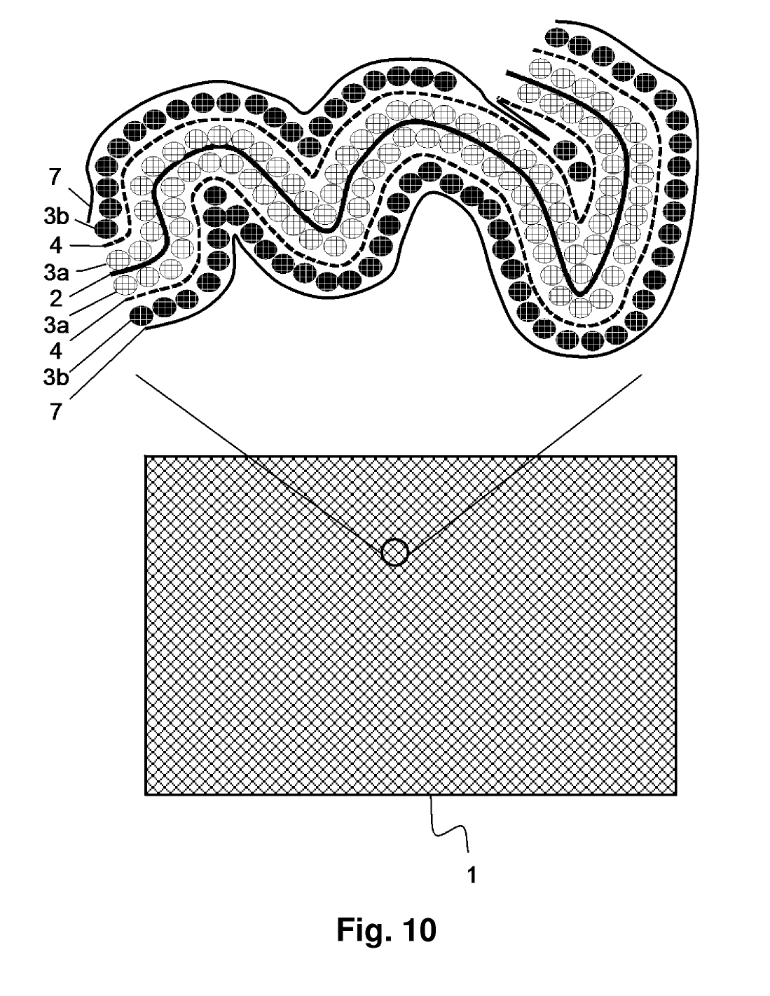

FIG. 10 shows, in schematic form, a galvanic cell according to a further preferred embodiment of the invention, in which the two electrodes of the cell are formed within the same shaped body 1 composed of porous carbon foam 2. In the upper part of the figure, a detail from the shaped body 1 marked in the lower part is shown schematically in significant magnification. As in the case of the individual electrode according to FIG. 1, first of all, a layer of active material 3a for a first of the two electrodes of the cell is disposed on the pore surface of the carbon foam 2. Atop that is a layer of solid-state electrolyte material 4. Unlike in the case of the electrode according to FIG. 1, however, this material does not completely fill the remaining cavities in the pores of the carbon foam 2 that are not claimed by the active material 3a. Instead, the layer of solid-state electrolyte material 4 is followed by a further layer of active material 3b which is chosen such that it acts as a counter-electrode to the first electrode. Finally, above that, there follows a further layer of a conductive material which acts as output conductors 7 for the second electrode. The output conductor layer for the second electrode may contain or preferably be manufactured at least essentially from copper especially in the case of a positive electrode, and aluminum in the case of a negative electrode. Moreover, the use of electrically conductive carbon as material is possible for both electrode types. The output conductor layer preferably fills the remaining cavities of the pores at least substantially, and in this case contains at least one structure from the conductive material which extends through a multitude of the pores as far as an outer face of the shaped body at which it can be connected to electrical contacts.

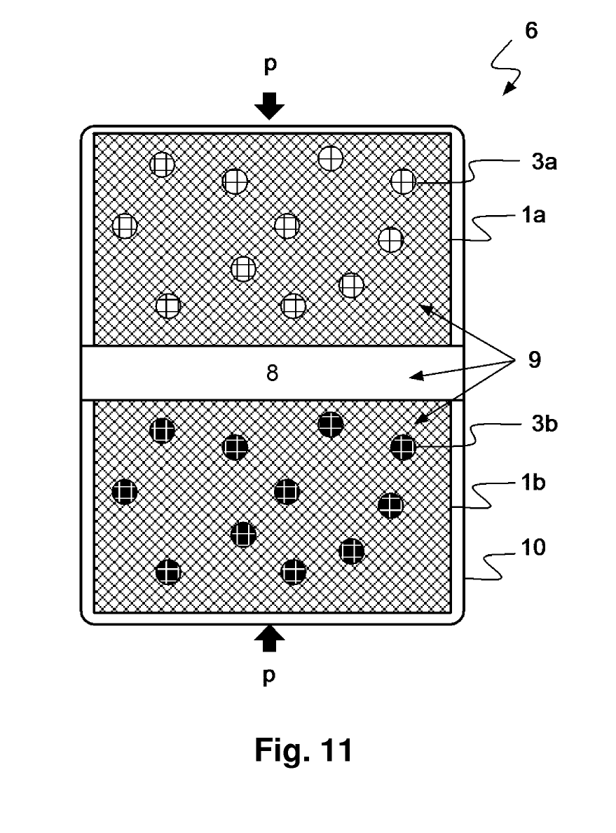

Finally, FIG. 11 shows a galvanic cell according to a further preferred embodiment of the invention. The cell has electrodes 1a and 1b each formed in a dedicated shaped body 1a or 1b composed of porous carbon foam 2. The electrodes correspond to those from FIG. 1, except that, by virtue of appropriate choice of the respective active material 3a or 3b, they take the form of opposite electrodes, i.e. of electrode and opposing counter-electrode. Moreover, they each do not contain any solid-state electrolyte material 4, but instead have corresponding remaining cavities in the shaped body 1. There is a separator layer 7 arranged between the two electrodes 1a and 1b, which is suitable for use with a liquid electrolyte. Separators of this kind are already known for conventional liquid electrolyte cells, especially lithium ion cells. The cell structure formed from the electrodes 1a and 1b and the separator layer 8 has been introduced into a closed housing 10, optionally for formation of a battery together with further, especially equivalent cell structures. The housing 10 has been filled at least partly with a liquid electrolyte 9 such that it has penetrated into the electrodes 1a and 1b and forms an ion conduction pathway between the two electrodes and via the separator layer 8. In addition, the housing can be configured such that the accommodation space provided for the accommodation of the cell can be adjusted in a variable manner, such that the cell can be put under pressure p in the case of corresponding reduction of the accommodation space (as indicated by the two arrows), especially before the liquid electrolyte is introduced. Alternatively, the cell may have been introduced into the accommodation space in the already compressed state, which has dimensions relative to the measurements of the cell such that it remains in a particular desired compression state in the housing. Thus, as already described above, the character of the cell can be established in a controlled manner as a power cell or energy cell.

In all the galvanic cells described here, moreover, in addition to the structures described, it is possible for output conductors or connections to be provided (not shown), in order to be able to form electrical contacts with the cell from the outside. The output conductors or connections may preferably have been mounted on the shaped body of the respective electrode to be contact-connected or, in the case of the cell from FIG. 10, on the common shaped body of the two electrodes. In the former case, it is in electrical contact with the electrically conductive carbon foam of the respective electrode 1a, 1b. In the case of FIG. 10, a first connection is in contact with the carbon foam 2 and, isolated from that, a second connection with the output conductor layer 7 of the second electrode, where the output conductor layer 7 of the second electrode forms a coherent structure within the shaped body 1 which is isolated from the carbon foam 2, and which can be externally contact-connected at at least one site to establish the corresponding connection.

While at least one illustrative embodiment has been described above, it should be noted that a large number of variations thereon exists. It should also be noted that the illustrative embodiments described constitute merely non-limiting examples, and there is no intention thus to restrict the scope, the applicability or the configuration of the devices and processes described here. Instead, the above description gives the person skilled in the art instructions for implementation of at least one illustrative embodiment, it being apparent that various alterations in the mode of function and the arrangement of the elements described in an illustrative embodiment can be undertaken without departing from the subject matter laid down in each case in the appended claims and the legal equivalents thereof.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE NUMERALS

1, 1 a,b shaped body, especially also electrode
2 carbon foam
3, 3a,b active material
4, 4a,b solid-state electrolyte (material)
5 separator layer of solid-state electrolyte (material)
6 galvanic cell
7 output conductor for a second electrode in the shaped body
8 separator layer for cell with liquid electrolyte
9 liquid electrolyte
10 housing, especially cell or battery housing

What is claimed is:

1. An electrode for use in a galvanic cell comprising:
a shaped body composed of porous carbon foam;
a first layer within the pores of the shaped body comprising electrochemically active material in electrically conductive contact with the shaped body; and
a second layer within the pores of the shaped body comprising a solid-state electrolyte material in contact with the active material of the first layer.

2. The electrode according to claim 1, wherein the galvanic cell is a lithium ion cell.

3. The electrode according to claim 1, wherein
the first layer has been formed on pore surfaces of the shaped body and is in electrically conductive contact with the shaped body; and
the second layer has been arranged at least partly atop the first layer, such that the following layer sequence is present at that point in the shaped body: carbon foam—active material—solid-state electrolyte.

4. The electrode according to claim 1, wherein,
on the shaped body composed of porous carbon foam,
the second layer has been formed on pore surfaces of the shaped body and is in contact with the shaped body, and
the first layer has been arranged at least partly atop the second layer, such that the layer sequence of carbon foam—solid-state electrolyte—active material is present at that point in the shaped body, and
the first layer is in electronically conductive contact with the shaped body at at least one point.

5. The electrode according to claim 1, wherein the shaped body and the first layer have been bonded by means of a binder.

6. The electrode according to claim 1, further comprising a layer which takes the form of a separator layer and has been arranged on at least one side of the outer surface of the shaped body and comprises a solid-state electrolyte material.

7. A galvanic cell comprising:
a first electrode having:
a shaped body composed of porous carbon foam,
a first layer within the pores of the shaped body comprising electrochemically active material in electrically conductive contact with the shaped body,
a second layer within the pores of the shaped body comprising a solid-state electrolyte material in contact with the active material of the first layer, and
a layer which takes the form of a separator layer and has been arranged on at least one side of the outer surface of the shaped body and comprises a solid-state electrolyte material; and
a second electrode having:
a shaped body composed of porous carbon foam,
a first layer within the pores of the shaped body comprising electrochemically active material in electrically conductive contact with the shaped body,
a second layer within the pores of the shaped body comprising a solid-state electrolyte material in contact with the active material of the first layer, wherein the active material of which has been chosen such that it acts as a counter-electrode to the first electrode;
wherein the two electrodes are arranged relative to one another such that the separator layer of the first electrode is arranged between the shaped body and the second electrode in order to separate them.

8. A galvanic cell comprising:
a shaped body composed of porous carbon foam;
a first layer of active material for a first electrode arranged atop the shaped body in the pores thereof, where the active material for the first electrode and the material of the layer composed of carbon foam have a different chemical composition;
a second layer which is arranged atop the first layer and takes the form of a separator layer and comprises a solid-state electrolyte material;
a third layer of active material for a second electrode which is arranged atop the second layer and has been chosen such that the second electrode acts as a counter-electrode to the first electrode;
so as to give the following layer sequence: carbon foam—active material of the first electrode—separator layer—active material of the second electrode.

9. A galvanic cell comprising:
a first electrode comprising a shaped body composed of porous carbon foam and an electrochemical active material which has been introduced into the shaped body and therein forms a first layer on pore surfaces of the shaped body which is in electrically conductive contact with the shaped body;
a second electrode, the active material of which has been chosen such that it acts as a counter-electrode to the second electrode;
a separator layer arranged between the first electrode and the second electrode; and
a liquid electrolyte which is present in the spatial region between the two electrodes and is in contact with the separator layer, such that the two electrodes are connected in an ion-conductive manner via the electrolyte and the separator layer.

10. An electrical energy store, comprising:
a housing; and
at least one galvanic cell according to claim 8 disposed in an accommodation space of the housing, wherein at least one shaped body of the cell is in elastic form and has been introduced into the accommodation space in a compressed state.

11. A process for producing the electrode of claim 1, comprising the steps of:
providing a shaped body composed of porous carbon foam, a carbon foam precursor or a combination of the two as a first component;
providing an active material for the electrode, a corresponding active material precursor or a combination of the two as a second component;
mechanically mixing the first component and the second component;
if the first component comprises a carbon foam precursor or the second component comprises an active material precursor, converting this/these precursor(s) in order to obtain the shaped body composed of the porous carbon foam with the active material for the electrode deposited in the pores thereof;
infiltrating the shaped body obtained with a third component comprising a solid-state electrolyte material, a corresponding solid-state electrolyte material precursor or a combination of the two; and
if the third component comprises a solid-state electrolyte material precursor, converting this precursor in order to produce a layer comprising the solid-state electrolyte material arranged atop the active material for the electrode in the shaped body.

12. A process for producing the electrode of claim 1, comprising the steps of:
providing a shaped body composed of porous carbon foam, a carbon foam precursor or a combination of the two as a first component;
providing a solid-state electrolyte material or a solid-state electrolyte material precursor or a combination of the two as a second component;
mechanically mixing the first component and the second component;
if the first component comprises a carbon foam precursor or the second component comprises a solid-state electrolyte material precursor, converting this/these precursor(s) in order to obtain the shaped body composed of the porous carbon foam with the solid-state electrolyte material deposited in the pores thereof;
infiltrating the shaped body obtained with a third component comprising an active material for the electrode, a corresponding active material precursor or a combination of the two; and
if the third component comprises an active material precursor, converting the active precursor in order to produce the active material layer arranged atop the solid-state electrolyte in the shaped body.

13. A process for producing the electrode of claim 1, comprising the steps of:
providing a carbon foam precursor as a first component, a solid-state electrolyte material or a solid-state electrolyte material precursor or a combination of the two as a second component, and a third component comprising an active material for the electrode, a corresponding active material precursor or a combination of the two;
mechanically mixing the first, second and third components;
converting any precursors present in the first, second and third components in order to obtain a shaped body composed of porous carbon foam, in the pores of which the solid-state electrolyte material and the active material for the electrode have been deposited,
wherein the converting is effected in such a way that the converting of the carbon foam precursor commences prior to the converting of any precursors present for the second and third components; and
wherein, in the mixing, the introduction of the second and third component(s) into the mixture begins successively or, when the second and third components contain precursors, the converting of the second and third components begins successively, wherein the sequence of introduction and conversion is chosen depending on the layer sequence of the components which is to be produced in the electrode.

14. A process for producing the galvanic cell of claim 6, comprising the steps of:
coating a first electrode with a layer of a material comprising a solid-state electrolyte to form a separator layer of the cell; and
arranging a second electrode, the active material of which has been chosen such that it acts as a counter-electrode to the first electrode, atop the separator layer such that it separates the first and second electrodes.

15. A process for producing the galvanic cell of claim 7, comprising the steps of:
providing a shaped body composed of porous carbon foam, a carbon foam precursor or a combination of the two as the first component;
introducing an active material for a first electrode, a corresponding active material precursor or a combination of the two as a second component into the first component;
if the first component comprises a carbon foam precursor or the second component comprises an active material precursor, converting this/these precursor(s) in order to obtain a shaped body composed of porous carbon foam with the active material for the first electrode deposited in the pores thereof;
infiltrating the shaped body obtained with a third component comprising a solid-state electrolyte material, a corresponding solid-state electrolyte material precursor or a combination of the two; and,
if the third component comprises a solid-state precursor material, converting this precursor in order to produce a layer comprising solid-state electrolyte material arranged within the shaped body atop the active material for the first electrode;
introducing an active material for a second electrode, a corresponding active material precursor or a combination of the two as a fourth component into the shaped body; and,
if the fourth component comprises an active material precursor, converting this precursor in order to produce a layer of active material for a second electrode atop the layer comprising the solid state electrolyte material.

16. A process for producing the galvanic cell of claim 8, comprising the steps of:
arranging between a first electrode, a second electrode and a separator layer in an accommodation space of a housing, such that the separator layer separates the first and second electrodes from one another, wherein the first electrode comprises a shaped body composed of porous carbon foam and an electrochemical active material which has been introduced into the shaped body and therein forms a first layer on pore surfaces of the shaped body which is in electrically conductive contact with the shaped body, and the active material of the second electrode is chosen such that it acts as a counter-electrode to the first electrode; and
filling the accommodation space with a liquid electrolyte, such that the electrolyte penetrates into the first electrode and is in contact with the separator layer and the second electrode, such that the two electrodes are connected in an ion-conductive manner via the electrolyte and the separator layer.
